(19) United States
(12) Patent Application Publication
(10) Pub. No.: US 2010/0026625 A1
(43) Pub. Date: Feb. 4, 2010

(54) CHARACTER INPUT DEVICE

(76) Inventor: Eui Jin OH, Daejeon (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/551,349

(22) Filed: Aug. 31, 2009

Related U.S. Application Data
(63) Continuation of application No. PCT/KR2008/001359, filed on Mar. 10, 2008.

(30) Foreign Application Priority Data
Mar. 8, 2007 (KR) 10-2007-0022807

(51) Int. Cl. G09G 5/00

(52) U.S. Cl. 345/156

(57) ABSTRACT

A character input device is disclosed. In one embodiment, the character input device includes an input unit, press detection units, movement detection units, and a control unit. The input unit is provided as a single body such that first directional input, which is performed by pressing one of first direction indication locations arranged radially from a reference location and spaced apart from one another, and second directional input, which is performed through movement from each of the first direction indication locations to one of second direction indication locations arranged radially around the first direction indication location, can be performed. The press detection units detect the first directional input. The movement detection units detect the second directional input. The control unit extracts a character code, assigned to each selected one of the direction indication locations, from a memory unit based on results of the detection.

### RELATED APPLICATIONS

This application is a continuation application, and claims the benefit under 35 U.S.C. §§120 and 365 of PCT Application No. PCT/KR2008/001359, filed on Mar. 10, 2008, which is hereby incorporated by reference.

The PCT application also claimed priority to and the benefit of Korean Patent Application No. 10-2007-0022807 filed on Mar. 8, 2007 in the Korean Intellectual Property Office, which is incorporated herein by reference.

This application also relates to U.S. patent application Ser. Nos. 12/358,148 and 12/358,161 both filed on Jan. 22, 2009, 12/364,417 filed on Feb. 2, 2009, and 12/428,392 filed on Apr. 22, 2009, all of which are incorporated by reference.

### BACKGROUND OF THE INVENTION

1. Field of the Invention

The present invention relates, in general, to a character input device, and, more particularly, to a character input device that is capable of inputting each of characters, numbers and symbols through a single action based on first, second, third or fourth directional input or combined directional input using a single input unit.

2. Description of the Related Technology

With the development of software and semiconductor technology and data processing technology, information devices are gradually becoming small, and the amount and importance of characters input using such information devices is gradually increasing.

### SUMMARY OF CERTAIN INVENTIVE ASPECTS

One aspect of the present invention is a character input device that is capable of inputting each of characters, numbers and symbols through a single action based on first, second, third or fourth directional input or combined directional input using a single input unit, thereby reducing the space required for character input and enabling fast and accurate character input.

Another aspect of the present invention is a character input device, including an input unit provided as a single body such that first directional input, which is performed by pressing one of first direction indication locations arranged radially from a reference location and spaced apart from one another, and second directional input, which is performed through movement from each of the first direction indication locations to one of second direction indication locations arranged radially around the first direction indication location, can be performed; press detection units for detecting the first directional input; movement detection units for detecting the second directional input; and a control unit for extracting a character code, assigned to each selected one of the direction indication locations, from a memory unit based on results of the detection of the press detection units and the movement detection units.

Combined directional input, to which characters, different from characters assigned to the first directional input and the second directional input, are assigned, is through combination of the first directional input and the second directional input.

Furthermore, the second directional input is configured to input respective characters for two or more respective radial directions.

Third directional input that is configured to input characters assigned to third direction indication locations arranged radially on an input unit is performed through movement of the entire input unit to the third direction indication location, and the character input unit further includes entire movement detection units provided on one side of the input unit or outside the input unit to detect the third directional input.

Furthermore, the character input device further includes a central input key provided at a reference location of the input unit and configured to perform fourth directional input through one or more of directional pressing and directional movement, and the central input key is provided with one or more of a press detection unit for detecting directional pressing and a movement detection unit for detecting directional movement.

The input unit is a ring-shaped integrated type input unit that is distributed and arranged radially around a reference location.

In this case, the character input device further includes a central input key provided at the reference location of the input unit and configured to perform fourth directional input through one or more of directional pressing and directional movement, and the central input key is provided with one or more of a press detection unit for detecting directional pressing and a movement detection unit for detecting directional movement.

Furthermore, the input unit includes a central region provided at a reference location and a plurality of surrounding input keys arranged radially from the central region and connected to the central region through elastic return elements, and first direction indication locations are provided for the respective surrounding input keys, and first directional input, which is performed through directional pressing of each of the first direction indication locations, and second directional input, which is performed through direction movement from each of the first direction indication location to each of second direction indication locations, arranged radially from the first direction indication location, based on deformation of an elastic element with respect to the central region, is performed.

In this case, when second directional input is performed using each of the surrounding input keys, a character, first assigned to the second direction indication location, or second characters, different from the character, are indicated at a movement and second direction indication location around a location at which the second directional input is performed, and one of the second characters can be input through second directional input for the movement and second direction indication location.

Furthermore, combined directional input, which is configured to input a newly assigned third character, is performed through combination of first directional input, second directional input and movement and second directional input for the surrounding input key.

Third directional input that is configured to input characters, assigned to third direction indication locations arranged radially on an input unit, is performed through movement of the entire input unit to the third direction indication locations, and the character input device further includes entire movement detection units provided on one side of the input unit or outside the input unit to detect the third directional input.

Meanwhile, the character input device further includes discriminative detection units configured to detect contact of a finger with each of the first direction indication locations so as to discriminate between the second directional input based on each of the second direction indication locations and the fourth directional input based on radial direction movement of the entire input unit.

Furthermore, the character input device further includes a center detection unit configured to detect contact of a finger with a reference location so as to discriminate between the second directional input based on each of the second direction indication locations and the fourth directional input based on radial direction movement of the entire input unit, and provided at the reference location.

In this case, the discriminative detection units and the center detection unit determine input in question to be the fourth directional input when contact of a finger with three or more first direction indication locations or two or more first direction indication locations and the reference location is detected, and determine the input in question to be second directional input for a second direction indication location around a first direction indication location, at which first contact is performed, when contact of a finger is detected by two or less first direction indication locations.

Furthermore, the character input device further includes return elements for returning the input unit to an original location thereof after the third directional input is performed.

Another aspect of the present invention is a character input device, including an input unit provided such that first directional input, which is performed through selection of one from among a plurality of first direction indication locations arranged radially on the input unit itself and spaced apart from one another, second directional input, which is performed through movement from each of first direction indication locations to each of second direction indication locations arranged circumferentially around the first direction indication location, and third directional input, which is performed through entire movement from a reference location to each of third direction indication locations arranged radially from the reference location and spaced apart from one another, can be performed; movement detection units for detecting the second directional input and the third directional input through the input unit; press detection units for detecting the first directional input; and a control unit for extracting a character code, assigned to each selected direction indication location, from a memory unit based on results of the detection of the movement detection units and the press detection units.

In this case, the third directional input is provided to be performed in multiple steps by varying a distance of movement of the input unit for each of the third direction indication locations.

Meanwhile, the first directional input is performed using any one of a method of tilting the input unit toward one of the first direction indication locations and a method of selecting one from directional pressing buttons provided on the input unit to correspond to the respective first direction indication locations.

Furthermore, the first directional input is provided to be performed in two or more steps, that is, in multiple steps, depending on the tilt angle of the input unit, the distance of pressing of the directional pressing button or the intensity of pressing.

The second directional input is performed in such a way that the input unit is rotated around the reference location in each of right and left directions.

The input unit is provided to enable input to be performed in two or more steps, that is, in multiple steps, in each of right and left directions depending on the distance of rotation around the reference location.

Central input that is performed using any one of a method of moving the entire input unit in a vertical direction or a method of selecting a central input key provided on the input unit can be performed.

In this case, the central input is provided to be performed in two or more steps, that is, in multiple steps, depending on a difference in distance of the vertical movement, a difference in distance of the pressing of the central input key, or a difference in pressing pressure.

Vowel characters are input through any one of the first, second and third directional input and consonant characters are input through the remaining input.

Furthermore, Mode Switch, a symbol, a number, Enter, space or Input Cancel is assigned to a first direction indication location, a second direction indication location or a third direction indication location, other than one or more first direction indication locations, one or more second direction indication location and/or one or more third direction indication locations to which characters have been assigned.

Furthermore, the character input device further includes return elements for returning the input unit to the reference location after the third directional input is performed.

The character input device further includes character display units provided on any one of the input unit and a casing in which the input unit is mounted, and configured to separately display characters, assigned to the respective direction indication locations, in response to input actions of the input unit when respective types of directional input are performed.

Consonant characters are input through the second directional input and the third directional input, and a vowel characters are input through the first directional input.

The movement detection units are provided to correspond to the respective first direction indication locations.

The character input device further includes a support unit for supporting a bottom of the input unit, the support unit comprises a plurality of fixed support parts provided opposite each other and a rotating support part provided between the fixed support parts, and configured to come into contact with any one of the plurality of fixed support parts while rotating along with the input unit, and the movement detection unit is provided on any one of a fixed support part and the rotating support part and detects contact between the fixed support part and the rotating support part.

Furthermore, the character input device further includes a support unit for supporting a bottom of the input unit, the support unit is provided with a contact protrusion extended from the support unit, and wherein the movement detection unit is provided on a path of rotation of the contact protrusion and detects contact with the contact protrusion when the support part rotates along with the input unit.

Prior to a detailed description of the present invention, it should be noted that all technical terms and scientific related terms that are not specially defined in the present specification have general meanings that are widely used in the technical field to which the present invention pertains. However, the following terms are defined in order to clarify the range of the present invention, as follows:

Another aspect of the invention is a character input device, comprising: an input unit provided such that i) first directional input which is selected by directional pressing or tilting one of a plurality of first direction indication locations arranged radially from a reference location and spaced apart from one another, ii) second directional input which is configured to be performed through directional movement from each of the first direction indication locations to one of a plurality of second direction indication locations arranged radially around the first direction indication location, and iii) combined directional input different from the first directional input and the second directional input through combination of the first directional input and the second directional input can be performed respectively; at least one press detection unit configured to detect the first directional input; at least one movement detection unit configured to detect the second directional input; and a control unit configured to extract and display a character code, assigned to each selected one of the direction indication locations, from a memory unit based on results of the detection of the press detection unit and the movement detection unit.

In the above device, third directional input for inputting characters assigned to third direction indication locations arranged radially from the input unit is configured to be performed through movement of the entire input unit to the third direction indication locations, and the character input device further comprises at least one entire movement detection unit provided on one side of the input unit or outside the input unit to detect the third directional input.

In the above device, the first to fourth directional inputs are configured to be performed in multiple steps of two or more. The above device further comprises at least one discriminative detection unit configured to detect contact of a finger with each of the first direction indication locations or a center detection unit configured to detect contact of a finger with the reference location so as to discriminate between the second directional input based on each of the second direction indication locations and the third directional input based on radial direction movement of the entire input unit.

The above device further comprises a central input key provided at the reference location of the input unit and configured to perform fourth directional input through one or more of the directional pressing and the directional movement; wherein the central input key comprises one or more of a press detection unit configured to detect the directional pressing and a movement detection unit configured to detect the directional movement.

In the above device, the input unit comprises a central region provided at the reference location and a plurality of surrounding input keys arranged radially from the central region and connected to the central region through elastic return elements; and the first direction indication locations are provided for the respective surrounding input keys, and the first directional input which is configured to be performed through the directional pressing of each of the first direction indication locations, and the second directional input which is configured to be performed through direction movement from each of the first direction indication location to one of the second direction indication locations arranged radially from the first direction indication location, based on elastic deformation of the input key with respect to the central region, are configured to be performed.

In the above device, third directional input for inputting characters assigned to third direction indication locations arranged radially from the input unit, is configured to be performed through movement of the entire input unit to the third direction indication locations, and wherein the device further comprises at least one entire movement detection unit provided on one side of the input unit or outside the input unit to detect the third directional input. The above device further comprises a return element configured to return the input unit to an original location thereof.

Another aspect of the invention is a character input device, comprising: an input unit provided such that i) first directional input which is configured to be performed through selection of one from among a plurality of first direction indication locations arranged radially on the input unit itself and spaced apart from one another, ii) second directional input which is configured to be performed through movement from each of the first direction indication locations to one of second direction indication locations arranged circumferentially around the first direction indication location, and iii) third directional input which is configured to be performed through entire movement from a reference location to one of third direction indication locations arranged radially from the reference location and spaced apart from one another can be performed respectively; at least one movement detection unit configured to detect the second directional input and the third directional input of the input unit; at least one press detection unit configured to detect the first directional input; and a control unit configured to extract and display a character code, assigned to each selected direction indication location, from a memory unit based on results of the detection of the movement detection unit and the press detection unit.

In the above device, the first to third directional inputs are configured to be performed in multiple steps of two or more on each of the direction indication locations. In the above device, the second directional input is configured to be performed in such a way that the input unit is rotated around the reference location in right or left direction. In the above device, central input that is configured to be performed by any one of a method of moving the entire input unit in a substantially vertical direction or a method of selecting a central input key provided on the input unit can be inputted in one step or more.

The above device further comprises a return element configured to return the input unit to the reference location. The above device further comprises at least one character display unit provided on any one of the input unit and a casing in which the input unit is mounted, and configured to separately display characters, assigned to the respective direction indication locations, in response to input actions of the input unit when each of directional inputs is performed.

The above device further comprises a support unit configured to support a bottom of the input unit; wherein the support unit comprises a plurality of fixed support parts provided opposite each other and a rotating support part provided between the fixed support parts, and configured to come into contact with any one of the plurality of the fixed support parts while rotating along with the input unit; and wherein the movement detection unit is provided on any one of the fixed support part and the rotating support part and detects contact between the fixed support part and the rotating support part.

The above device further comprises a support unit configured to support a bottom of the input unit; wherein the support unit comprises a contact protrusion extended from the support unit; and wherein the movement detection unit is provided on a path of rotation of the contact protrusion and is configured to detect contact with the contact protrusion when the support part rotates along with the input unit.

Still another aspect of the invention is a character input device, comprising: an input unit provided such that i) first directional input which is selected by directional pressing or tilting one of a plurality of first direction indication locations arranged radially from a reference location and spaced apart from one another, ii) second directional input which is configured to be performed through directional movement from each of the first direction indication locations to one of a plurality of second direction indication locations arranged radially around the first direction indication location, and iii) combined directional input different from the first directional input and the second directional input through combination of the first directional input and the second directional input can be performed respectively; first detection means for detecting the first directional input; second detection means for detecting the second directional input; and means for extracting and displaying a character code, assigned to each selected one of the direction indication locations, from a memory unit based on results of the first and second detection means.

### BRIEF DESCRIPTION OF THE DRAWINGS

FIG. 1 is a perspective view of a portable mobile communication terminal equipped with a character input device according to an embodiment of the present invention.

FIG. 2 is a conceptual diagram illustrating an input method for a character input device according to a first embodiment of the present invention.

FIG. 3 is a conceptual diagram showing a variation of the first embodiment of the present invention.

FIG. 4 is a plan view showing a variation of the input unit in the first embodiment of the present invention.

FIG. 5 is a conceptual diagram illustrating an input method for a character input device according to a second embodiment of the present invention.

FIG. 6 is a plan view illustrating a method of detecting first directional input, second directional input and third directional input in the second embodiment of the present invention.

FIG. 7 is plan view illustrating a method of discriminating between respective types of directional input in the second embodiment of the present invention.

FIG. 8 is a plan view showing an example in which the character input device according to the second embodiment of the present invention is implemented on a touch pad.

FIG. 9 is a perspective view showing an example in which the character input device according to the second embodiment of the present invention is used as a mouse.

FIG. 10 is a conceptual view illustrating an input method for a character input device according to a third embodiment of the present invention.

FIG. 11 is a plan view showing a method of detecting first directional input, second directional input and third directional input in the third embodiment of the present invention.

FIG. 12 is a plan view showing a support part according to the third embodiment of the present invention, which illustrates second directional input through the rotation of the input unit.

FIGS. 13 and 14 are plan views showing the arrangements of characters in the third embodiment of the present invention.

FIG. 15 is a sectional perspective view showing a variation of the third embodiment of the present invention.

FIGS. 16 and 17 are plan views showing other variations of the third embodiment of the present invention.

FIG. 18 is a diagram showing a character input device according to a fourth embodiment of the present invention, wherein FIG. 18(c) is a sectional view taken along line A-A′ of FIG. 18(b).

FIG. 19 is a perspective view showing a variation of the fourth embodiment of the present invention.

FIG. 20 is a sectional view showing the relationship between the heights of a central input key and a ring-shaped input unit in the fourth embodiment of the present invention.

FIG. 21 is a plan view showing a character input device according to a fifth embodiment of the present invention.

FIGS. 22 and 23 are plan views illustrating combined input in the fifth embodiment of the present invention.

### DETAILED DESCRIPTION OF CERTAIN INVENTIVE EMBODIMENTS

The input of various characters or instructions to such information devices exhibits many problems. For example, input devices, such as keyboards, used in personal computers (PCs) or notebook computers cause difficulty in realizing small-sized information devices because there is a limitation on the reduction in the size thereof, and touch screen schemes used in personal data assistants (PDAs) and keypad schemes used in mobile phones are inconvenient because the speed of input is slow and the incidence of erroneous input is high.

In order to input letters, numbers and symbols to the above-described information devices, such as PCs, notebook computers, PDAs or mobile phones, at a higher speed, it is desirable to perform a so-called one stroke-one phoneme input, in which one phoneme character is input through one input action at a higher speed. When such one stroke-one phoneme input is applied to the Korean alphabet, it is desirable to provide buttons or input keys for inputting 24 or more characters on an information device. When the target language of input is English, Japanese or some other language, a larger number of buttons or input keys is required than in the case of the Korean alphabet.

However, since input devices used in various types of information devices adopt a scheme of assigning characters to respective input keys and inputting the characters by striking or pressing the input keys using fingers, it is difficult to arrange 24 or more finger-sized input keys on a personal mobile information terminal having a small area for the arrangement of input keys, such as a mobile phone.

This is the reason why it has been difficult to realize small-sized keyboards to date. In the case of mobile phones, since 24 or more Korean alphabet letters are input using only 12 buttons, a plurality of letters are arranged on each button, with the result that a repeated input phenomenon, in which an input action is repeated twice or three times to input one letter (phoneme), occurs frequently. Accordingly, input is slow and inconvenient.

Although a character input method of inputting characters through combination, known as Cheonjiin, has been proposed in order to overcome the above problem, the repeated input phenomenon is not solved using this method.

Furthermore, technologies, including a roll-up keyboard, which can be rolled up and then carried, and a virtual laser keyboard, which is configured to project an image of a keyboard onto a surface, detect the locations of fingers when actions similar to keyboard input actions are perform on the image using the fingers and receive input, have be proposed.

However, such types of input devices have problems in that they are inconvenient in that they need always to be carried, and in that the types of input device are not suitable for application to personal portable information terminals requiring input in the state in which the personal portable information terminals are held in the hands while moving because input can be performed only in the state in which those types of input devices are placed on support surfaces.

In the detailed description, the term “first directional input P” refers to the input of a character, a number or a symbol, desired by a user, by pressing a first direction indication location of an input unit 10 or tilting the input unit 10 toward the first direction indication location.

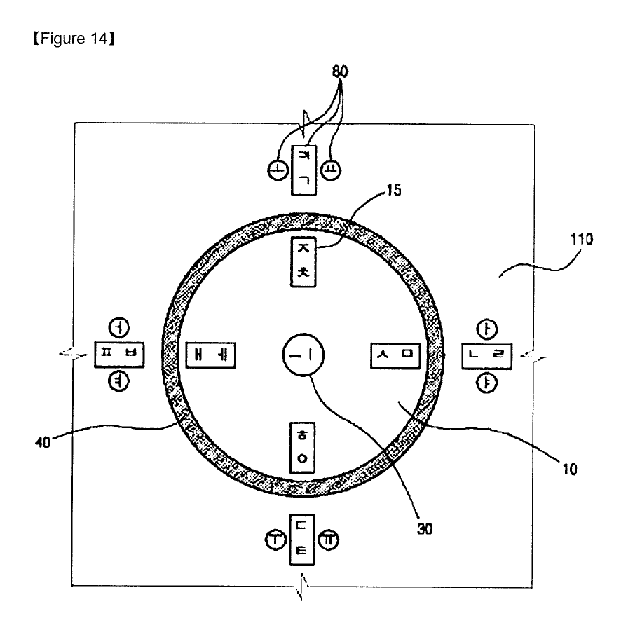

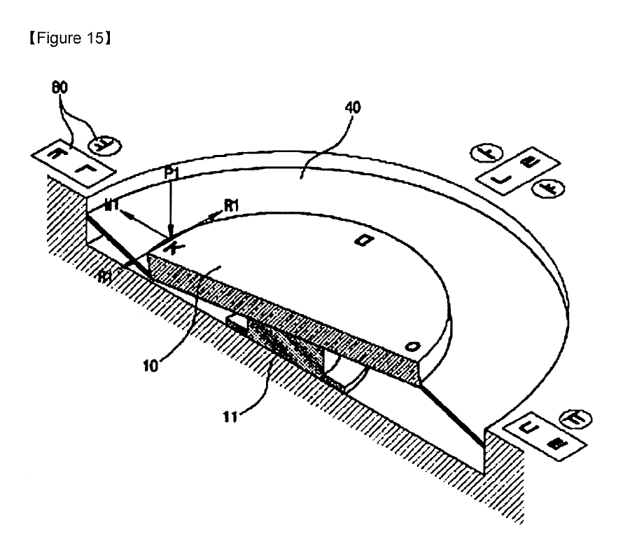

Directional pressing input P may be performed by providing directional pressing buttons 15 on the top of the input unit 10 to correspond to respective first direction indication locations P1, P2, P3 and P4, as shown in FIGS. 13 and 14, or tilting the input unit 10 toward each of the first direction indication locations P1, P2, P3 and P4, as shown in FIG. 15.

The term “second directional input M” refers to a desired character, number or symbol through contact with or the pressing of each of second direction indication locations arranged radially around each of the first direction indication locations of the input unit 10. The second directional input includes the type of input in which a character or the like is input through the action of moving the input unit 10 in a radial direction from a first direction indication location.

The term “third directional input R” refers to the input of a character, a number or a symbol, desired by a user, through the movement of all of the input keys 10, such as the displacement (lateral or sliding movement) of the entire input unit 10 in a certain direction in the same plane provided in the character input device, or the tilting of a stick-type input unit, such as a joystick, at a certain angle or in a certain direction.

The term “fourth directional input C” refers to the input of a character, a number or a symbol, desired by a user, through the action of performing directional movement or directional pressing on a central input key 30. Here, since the fourth directional input C is performed on the central input key 30, the fourth directional input C may be considered to be a type of central input.

However, the type of action of the input unit 10 is not limited to the above-described types. The input unit 10 is made of elastic flexible material, and may be provided with detection means capable of detecting slight movement of the input unit 10.

In the above-described case, when force is applied to the input unit 10 in a lateral or vertical direction, the effect in which the input unit 10 has been moved and input has been performed can be transferred to a control unit (not shown), even though the location of the entire input unit 10 is not changed.

Accordingly, the “second directional input M” in the present specification is not limited to the action and type of the input unit 10. The second directional input includes all the actions of providing a result in which the input unit 10 has been moved and input has been performed to the control unit of the character input device, including the action of pushing the input unit 10 in a lateral direction or a direction similar to the lateral direction (or applying force).

The term “vowel” refers to a character, the sound of which corresponds to a vowel of the Korean alphabet in the case of a foreign language, or a character that belongs to an alphabet group having a smaller number of characters when the alphabet of a foreign language is divided into two groups according to linguistic classification criteria.

The term “character” refers not only to a character in a narrow sense, that is, a language-based character, such as a Korean alphabet character, an English character or a Japanese character, but also to numbers, symbols and the like.

Embodiments of the present invention will be described in detail below with reference to the accompanying drawings.

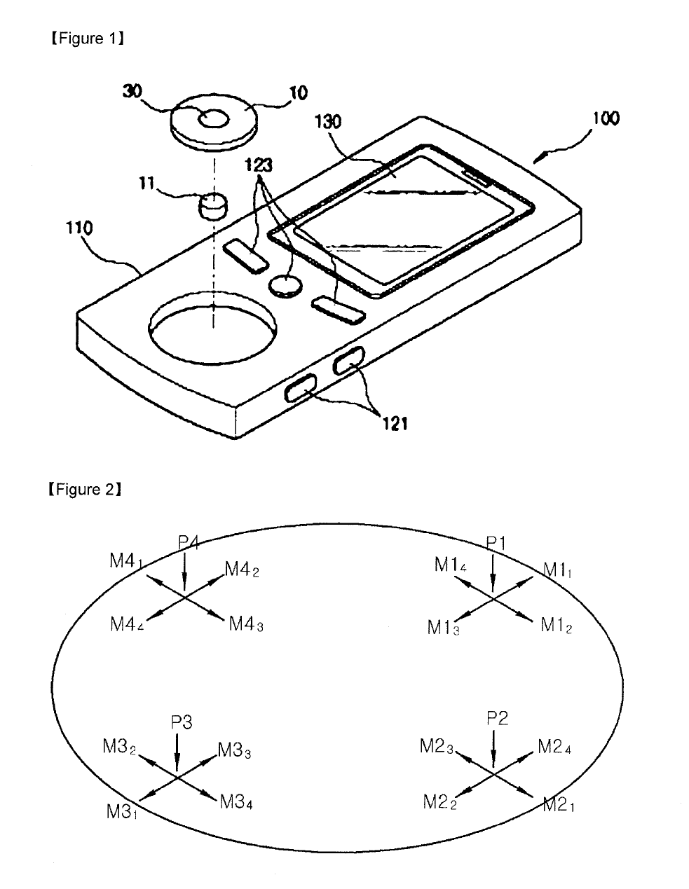

Referring to FIG. 1, a character input device according to one embodiment of the present invention includes an input unit 10 provided as a single body such that first directional input P, which is performed by pressing one of first direction indication locations P1, P2, P3 and P4 arranged radially from a reference location and spaced apart from one another, and second directional input M, which is performed through movement from each of the first direction indication locations P1, P2, P3 and P4 to each of second direction indication locations M1, M2, M3 and M4 arranged radially around each of the first direction indication locations P1, P2, P3 and P4, can be performed; press detection units 60 for detecting the first directional input P; movement detection units 50 for detecting the second directional input M; and a control unit (not shown) for extracting a character code assigned to a selected one of the direction indication locations from a memory unit (not shown) based on the results of the detection of the press detection units 60 and the movement detection units 50.

FIG. 1 is a perspective view of a portable mobile communication terminal 100 equipped with the character input device according to a first embodiment of the present invention.

Referring to this drawing, the character input device is installed on one side of a casing 110, and a display unit 130 for displaying characters input through the character input device is provided on the other side of the casing 110.

Meanwhile, a switching key 121 for switching the input mode of the character input device and function keys 123, such as an Enter key, a space key, a Cancel key and a Send/End key, may be provided on the casing 110.

Referring to FIG. 2, in the character input device according to the present embodiment, the input unit 10 is provided such that first directional input P, second directional input M and combined directional input R can be performed.

The first directional input P is performed by pressing one of the first direction indication locations P1, P2, P3 and P4 provided on the input unit 10, as described above. The first directional input P may be performed in such a way as to provide directional pressing buttons 15 on the input unit 10 to correspond to respective first direction indication locations P1, P2, P3 and P4 and press one of the directional pressing buttons 15, as shown in FIG. 13, or may be performed by tilting the input unit 10 in a relevant direction, as shown in FIG. 15.

Here, the directional pressing buttons 15 and means for detecting the tilting of the input unit 10 function as the press detection unit 60 for detecting the first directional input P.

The first directional input P may be provided to be performed in two or more steps, that is, in multiple steps. In the case of the above-described directional pressing buttons 15, discrimination is performed based on the difference in the vertical pressing distance or the intensity of pressing pressure, and then relevant first directional input is performed.

Furthermore, the second directional input M is configured to input a character, assigned to a second direction indication location, by performing movement from one of the first direction indication locations P1, P2, P3 and P4 to one of the second direction indication locations M1₁, . . . , M2₁, . . . , M3₁, . . . , M4₁, . . . , which are arranged radially around the first direction indication locations, using the single-body input unit 10. That is, as shown in FIG. 2, the second directional input M is configured to input a character, assigned to one of the second direction indication locations M1₁, . . . , M2₁, . . . , M3₁, . . . , M4₁, . . . , through movement in one of the radially inward, radially outward, left circumferential and right circumferential directions from one of the first direction indication locations P1, P2, P3 and P4.

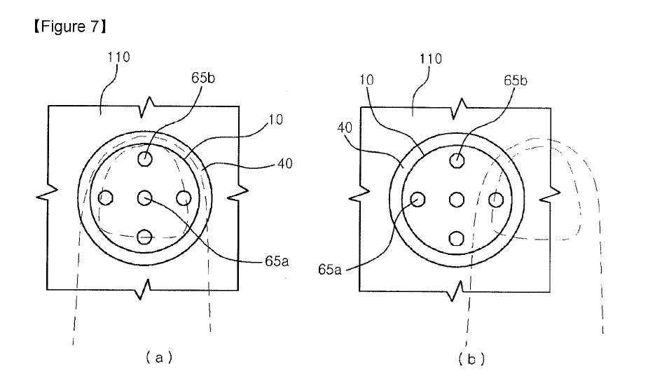

In this case, the movement detection units 50 (see 50a, 50b, 50c and 50d in FIG. 6) for detecting second directional input M are provided at each of the second direction indication locations M1₁, . . . , M2₁, . . . , M3₁, . . . , M4₁, . . . . Accordingly, when second directional input M to a second direction indication location in a specific direction is performed, a movement detection unit 50 detects the movement and inputs a character corresponding to a character assigned to the second direction indication location to the control unit.

The second directional input M may be provided to be performed in two or more steps, that is, in multiple steps, based on the distance of movement in each direction. That is, when two movement detection units 50 are arranged at different locations along a path to each of the second direction indication locations M1₁, . . . , M2₁, . . . , M3₁, . . . , M4₁, . . . , first-step second directional input M and second-step second directional input M are enabled based on the distance of movement to each of the second direction indication locations.

Meanwhile, the combined directional input R refers to input that is performed through the combination of first directional input P and second directional input M. That is, when second directional input M is performed immediately after first directional input P is performed at a specific one of the first direction indication locations P1, P2, P3 and P4, input is recognized as combined directional input R, so that a character assigned to one of the first direction indication locations P1, P2, P3 and P4 or a character assigned to one of the second direction indication locations M1₁, . . . , M2₁, . . . , M3₁, . . . , M4₁, . . . is not input, but a different new character is input.

Although, in the present embodiment, the first direction indication locations are illustrated as being arranged in four directions and the second direction indication locations are illustrated as being arranged in four directions, as an example, the present invention is not limited thereto, but they may be arranged in five, six, seven or eight directions.

Furthermore, if the number of characters that can be input is less than the number of required characters, the number of available characters can be increased by configuring the input unit 10 in two sets or configuring each of the first directional input P, the second directional input M and the combined directional input R in multiple steps.

Furthermore, in the character input device according to one embodiment of the present invention, the number of respective direction indication locations and the determination of whether to input in multiple steps can be freely changed depending on the number of characters/numbers/symbols that arc desired to be arranged.

That is, according to the input unit 10 of the present embodiment, four characters can be input through first directional input P for the first direction indication locations arranged radially around a reference location in four directions, 16 characters can be input through second directional input M for the four second direction indication locations arranged radially around each of the first direction indication locations, and 16 characters can be input through combined directional input R. Accordingly, a total of 36 characters can be input using the input unit 10.

Accordingly, even after 24 Korean alphabet characters (or 26 English alphabet characters) have all been arranged, symbols/numbers/function keys can then be arranged.

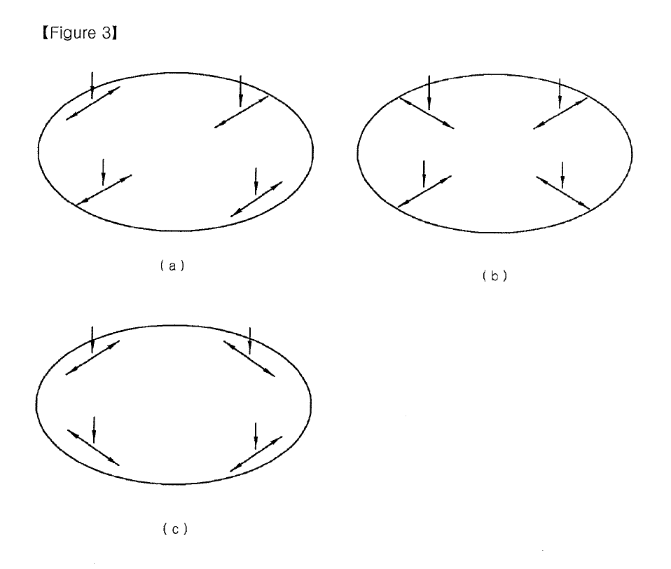

Meanwhile, the second direction indication locations may be provided such that second directional input M is performed in the directions shown in FIGS. 3(a) to 3(c). In greater detail, the second direction indication locations are arranged in vertical directions extending from the first direction indication locations, as shown in FIG. 3(a), and thus the second directional input M enables characters to be input through movement in the vertical directions from the respective first direction indication locations.

Furthermore, the second direction indication locations are arranged in radially inward and outward directions extending from the first direction indication locations, as shown in FIG. 3(b), and thus the second directional input M enables characters to be input through movement in a radially inward or outward direction from the respective first direction indication locations.

Moreover, the second direction indication locations may be arranged in inclined directions extending from the first direction indication locations, as shown in FIG. 3(c), and thus the second directional input M enables characters to be input through movement in two inclined directions from the respective first direction indication locations.

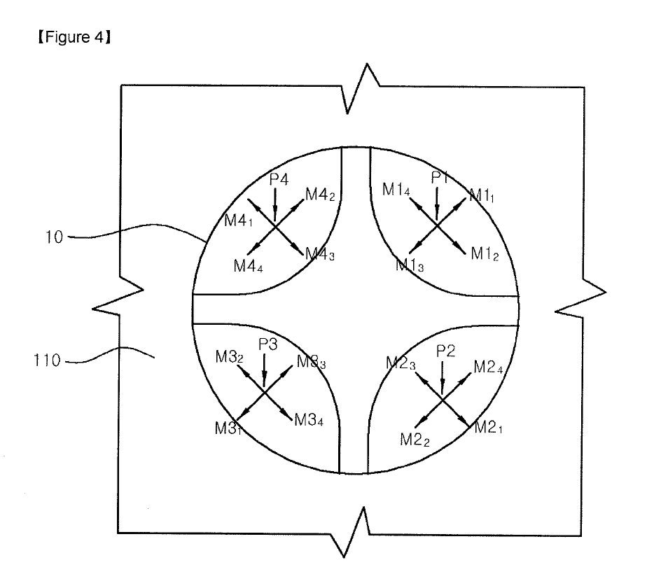

Furthermore, the input unit 10 shown in FIG. 2 is formed as a single body, as shown in FIG. 4, and respective first direction indication locations P1, P2, P3 and P4 may be divided and then provided. That is, a region including each of the first direction indication locations P1, P2, P3 and P4, which are provided to be arranged radially from a reference location in four directions and be spaced apart from one another, is provided separately from the other regions. In this case, regions including the first direction indication locations P1, P2, P3 and P4 may be provided at a position lower than that of a central region.

Furthermore, in this case, respective regions including the first direction indication locations P1, P2, P3 and P4 are separate from one another, but first directional input P, second directional input M and combined directional input R are performed in the same way.

Next, a character input device according to a second embodiment of the present invention will be described.

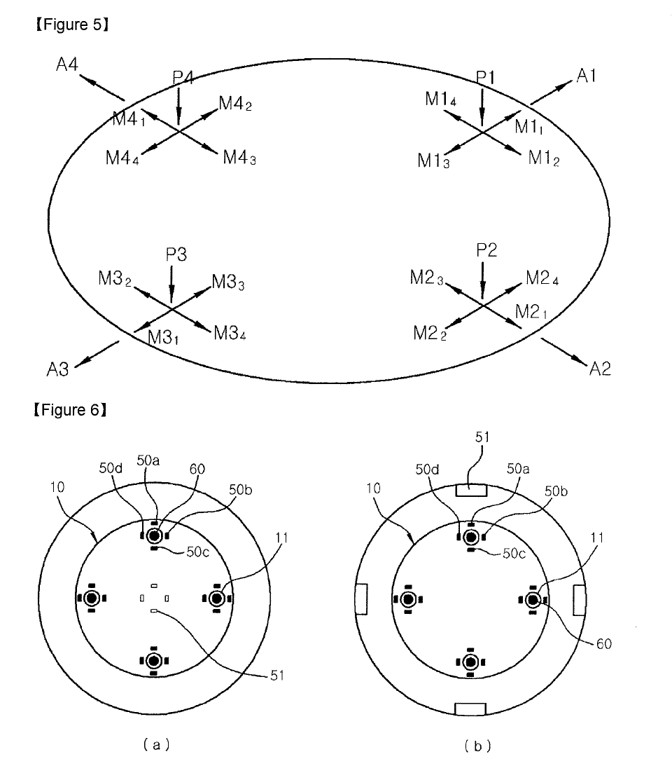

First directional input P in an input unit 10 shown in FIG. 5 is performed in the same way as in the first embodiment.

Furthermore, in a way similar to that of the first embodiment, second directional input M is performed through movement to each of second direction indication locations M1₁, . . . , M2₁, . . . , M3₁, . . . , M4₁, . . . arranged radially around the first direction indication locations P1, P2, P3 and P4.

Furthermore, in the present embodiment, the entire input unit 10 can be moved radially, and third directional input A can be performed though this movement. That is, the third directional input A is configured to input characters assigned to third direction indication locations A1, A2, A3 and A4, which are arranged in radially outward directions, as the entire input unit 10 is moved radially outwards.

Entire movement detection units 51 are further provided to detect the third directional input A. The entire movement detection units 51 may be provided on one side of the input unit 10 (see FIG. 6(a)) or outside the input unit 10 (see FIG. 6(b)) in order to detect the movement of the input unit 10.

In the present embodiment, since the input unit 10 can be moved, press detection units 60 may be provided at the first direction indication locations P1, P2, P3 and P4 and center detection units or discriminative detection units 65 may be further provided, in order to discriminate between the second directional input M and the third directional input A.

That is, the second directional input M may be independently performed by detecting movement to each of second direction indication locations using the movement detection unit 50, or may be performed by radially moving the input unit 10 in the state in which the press detection unit 60 is pressed and detecting the movement using each of the entire movement detection units 51.

Furthermore, when the second directional input M is independently performed, a center detection unit 65a or discriminative detection units 65b, capable of detecting the contact of a portion of the finger is further provided, and can detect the location of the second directional input M. In the present embodiment, an example of the case in which both the center detection unit 65a and the discriminative detection units 65b are provided is presented. That is, as shown in FIG. 7, the discriminative detection units 65b are respectively provided at the first direction indication locations P1, P2, P3 and P4, and the center detection unit 65a is provided at a reference location.

Accordingly, as shown in FIG. 7(a), when a finger is placed on the entire input unit 10, the center detection unit 65a and all of the discriminative detection units 65b detect contact with the finger, and thus the movement of the input unit 10 in this state is identified as third directional input A. Meanwhile, as shown in FIG. 7(b), when a finger is placed on a specific one of the first direction indication location locations P1, P2, P3 and P4 to perform second directional input M at the specific first direction indication location, a discriminative detection unit 65b placed on the specific first direction indication location detects contact with the finger, and thus the movement of the input unit 10 in this state is identified as second directional input M.

Meanwhile, as shown in FIG. 7(a), when a finger is placed on the entire input unit 10, it may be identified as a collective input mode. This mode is contrasted with an individual input mode in which a finger is placed on a specific first direction indication location, as shown in FIG. 7(b). When input in the individual input mode is performed in the collective input mode, a character different from that in the individual input mode may be input.

For example, in the case in which ‘ [symbol] ’ is input through first directional input P at a specific first direction indication location in the individual input mode, ‘ [symbol] ’, rather than ‘ [symbol] ’, may be input when first directional input P at the first direction indication location is performed in the collective input mode.

Accordingly, if the collective input mode and the individual input mode are discriminated from each other using the center detection unit 65a and the discriminative detection units 65b in the case in which first directional input P, second directional input M and combined directional input R can be performed in the individual input mode, the input actions in the individual mode can be implemented in the collective input mode, and the characters to be input can be varied, so that the collective input mode can increase the capacity to input characters to a capacity two time as high as that in the individual input mode.

Meanwhile, as shown in FIG. 7, since the input unit 10 is configured to have a size that can be covered with a single finger, it may be difficult to bring a finger into contact only with a specific first direction indication location. Accordingly, in the present embodiment, when the contact of a finger with two first direction indication locations is detected, it is determined that the second directional input M is performed at a first direction indication location, corresponding to the discriminative detection unit 65 that first detects the contact of the finger.

Furthermore, the press detection units 60, rather than the discriminative detection units 65, may have a pressure detection function to perform a discriminative detection function. That is, since the press detection units 60 are pressed when a finger is placed on the entire input unit 10, third directional input A is detected when the input unit 10 is moved in this state, and second directional input M is detected when the input unit 10 is moved in the state in which a press detection unit 60 at a specific first direction indication location is pressed.

Since a pressure higher than those at the other press detection units 60 is detected at the press detection unit 60 when second directional input M is performed in a radial direction to a specific first direction indication location, it is determined that second directional input M is performed at the first direction indication location.

Here, the pressure detection function of the press detection units 60 may be implemented using pressure sensors or the like.

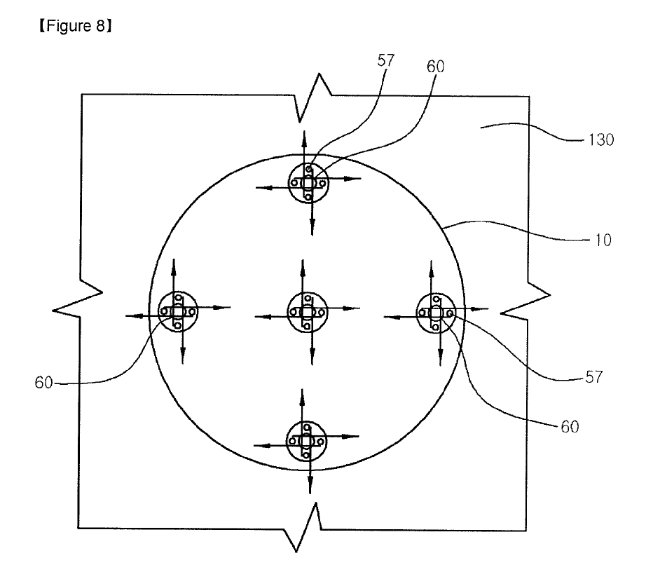

Meanwhile, when the input unit 10 is implemented using a touch pad method, touch detection units 57 can be provided on the input unit 10 displayed on a display unit 130 to detect the second directional input M. That is, second directional input M may be performed in such a way that a plurality of touch detection units 57 is provided around each of the press detection units 60, as shown in FIG. 8, the touch detection unit 57 detects the direction of the movement of a finger, and a character assigned to a specific second direction indication location is input.

Furthermore, although, in the present embodiment, the first direction indication locations, the second direction indication locations and the third direction indication locations are illustrated as being arranged in four radial directions, it is apparent that they may alternatively be arranged in five, six, seven or eight directions.

If the number of characters that can be input is less than the number of required characters, the number of available characters can be increased by configuring the input unit 10 in two sets or configuring first, second and third directional input P, M, A so that each of them is performed in multiple steps.

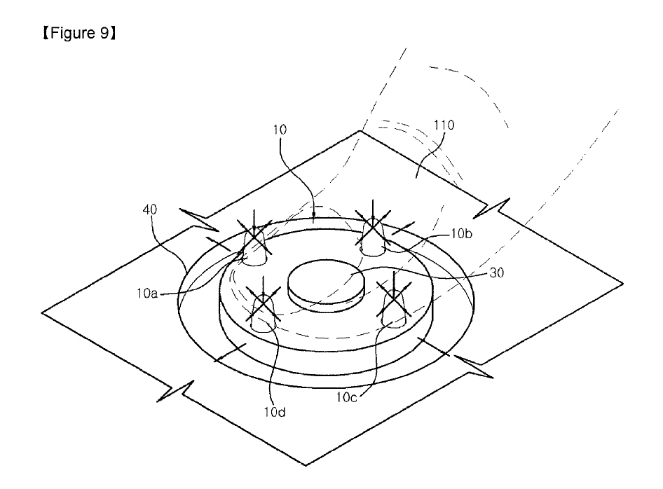

Furthermore, since the input unit 10 is included in the range covered with a finger, the input unit 10 may be provided to perform a mouse function. That is, when an input unit 10 is provided, as shown in FIG. 9, a mouse point may be moved through the directional input of a center input key 30, and the functions of the left and right buttons of a mouse may be performed using stick-shaped surrounding input keys 10a, 10b, 10c and 10d arranged at the first direction indication locations. Accordingly, the present embodiment has advantages in that simultaneous actions, such as the dragging of a mouse or file dragging, can be performed and the movement of a character and a command can be simultaneously performed when the present embodiment is implemented in a game.

Furthermore, in the present embodiment, the same character set may be assigned to second directional input M and third directional input A. That is, a character set assigned to four second direction indication locations provided for each of first direction indication locations in four directions is made the same as a character set assigned to third direction indication locations in four directions, and thus, the same result can be achieved even through two different types of second directional input M in such a way that third directional input A is performed immediately after second directional input M in a specific direction is performed.

Next, a character input device according to a third embodiment of the present invention will be described.

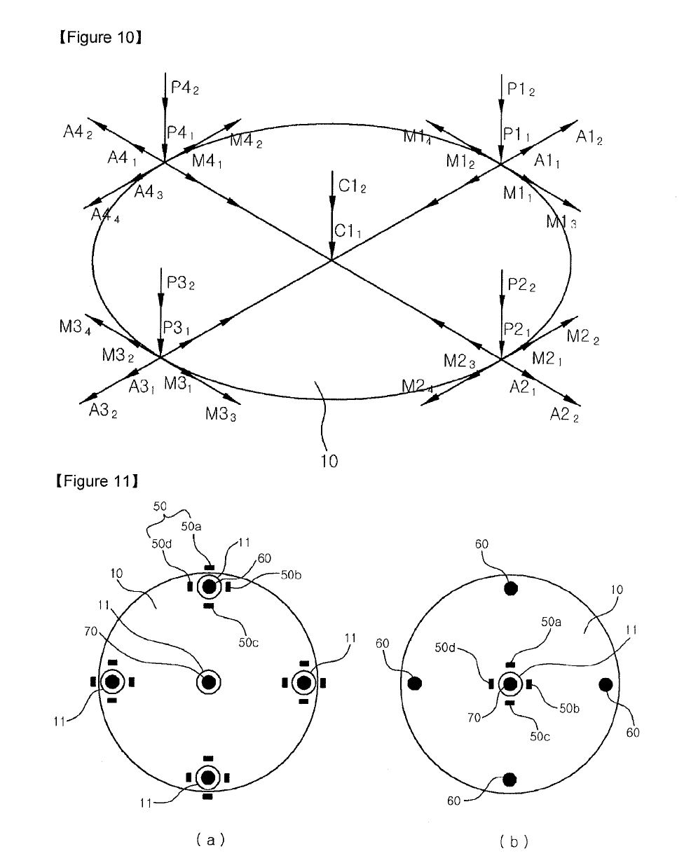

Referring to FIG. 10, in the character input device according to one embodiment of the present invention, an input unit 10 is provided to perform first directional input P, second directional input M, and third directional input A.

The first directional input P is performed in the same way as the first directional input P in the first embodiment.

That is, the first directional input P may be performed by providing directional pressing buttons 15 on the input unit 10 to correspond to respective first direction indication locations P1, P2, P3 and P4, as shown in FIG. 13, or by tilting the input unit 10 in a relevant direction, as shown in FIG. 15.

The first directional input P may be provided to be performed in two or more steps, that is, in multiple steps. In the case of the above-described directional pressing buttons 15, discrimination is performed based on the difference in the (vertical) pressing distance or the intensity of pressing pressure.

Furthermore, the second directional input M is similar to the second directional input M in the first embodiment, and is performed by moving the input unit 10 from each of the first direction indication locations P1, P2, P3 and P4 to each of second direction indication locations M1₁, . . . , M2₁, . . . , M3₁, . . . , M4₁, . . . , which are radially arranged. The second directional input M may be performed by first inputting the first directional input P in the input unit 10 and then moving the input unit 10 from a relevant location in the radial direction.

Meanwhile, the third directional input A is similar to the third directional input A in the second embodiment, and is configured to input characters assigned to the third direction indication locations A1, A2, A3 and A4 as the entire input unit 10 is moved from a reference location in respective radial directions.

The third directional input A may be also provided to be performed in two or more steps, that is, in multiple steps, based on the distance of movement of the input unit 10.

That is, when two or more entire movement detection units 51 are arranged at different locations in the path of the input unit 10 extending from the reference location, a first-step third directional input A and a second-step third directional input A can be performed depending on the distance of the movement of the input unit 10.

In the above case, in order to discriminate between the first directional input P and the second directional input M when the second directional input M is performed by first performing the first directional input P in the input unit 10 and moving the input unit 10 from a relevant location in a radial direction, the first directional input P may be ignored and only the second directional input M may be effectively performed when the movement of the input unit 10 is detected immediately after the first directional input P is performed.

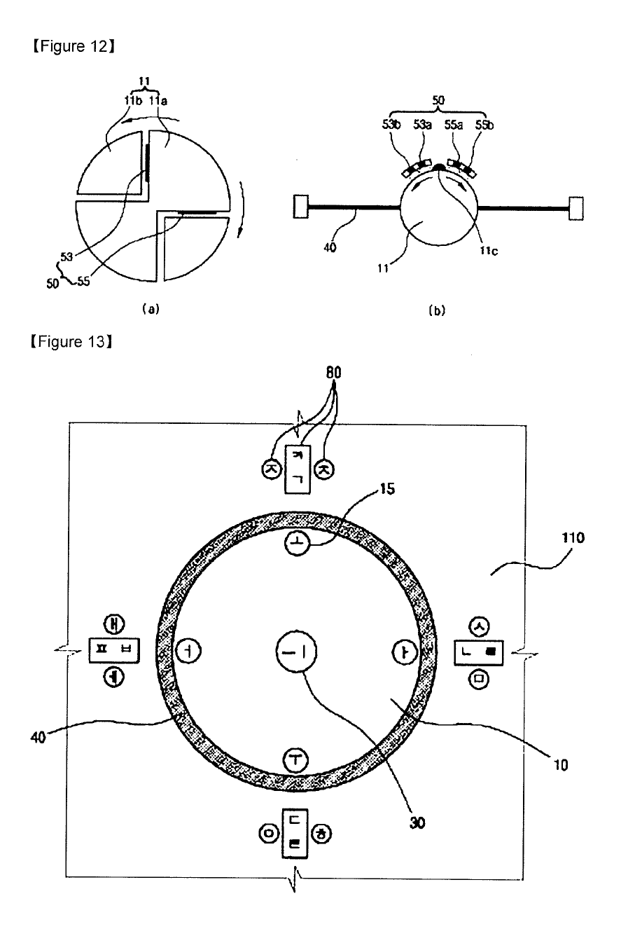

Here, although the second directional input M may be performed through the radial movement of the input unit 10, the second directional input M may be performed through the left and right rotation of the input unit 10 (that is, circumferential rotation), as shown in FIG. 12.

For this purpose, as shown in FIG. 12(a), a support unit 11 is formed of a fixed support part 11b and rotating support parts 11a, and the direction of contact between a rotating support part 11a and the fixed support part 11b can be detected when the input unit 10 is rotated. That is, the second directional input M can be detected in such a way that a left movement detection unit 53 performs detection when the input unit 10 is rotated counterclockwise and the right movement detection unit 55 performs detection when the input unit 10 is rotated clockwise.

Alternatively, as shown in FIG. 12(b), a contact protrusion 11 is provided on one side of the input unit 10 and a movement detection unit 50 (53a, 53b, 55a and 55b) is disposed within the radius of rotation of the contact protrusion 11c, thereby detecting both the direction and angle of the rotation of the input unit 10 and then enabling second directional input M in multiple steps.

That is, when the input unit 10 is rotated clockwise and comes into contact with the right movement detection unit 55a, first-step second directional input M (M1₁ in FIG. 10) is performed. In contrast, when the input unit 10 is further rotated, the input unit 10 comes into contact with the rightmost movement detection unit 55b, and second-step second directional input M (M1₃ in FIG. 10) is performed.

Here, reference numeral 40 designates a return element. The return element 40 includes an elastic material, and is provided to return the input unit 10, with which second directional input M or third directional input A has been performed, to the original position thereof.

It is apparent that the second directional input M can be implemented using various methods, in addition to the above-described structure.

FIGS. 11(a) and 11(b) show the arrangements of respective detection units that are used to detect the first directional input P, the second directional input M and the third directional input A in the character input device according to the present embodiment.

As shown in FIG. 11(a), the movement detection units 50 and the press detection units 60 may be provided at respective first direction indication locations and respective second direction indication locations. As shown in FIG. 11(b), the movement detection units 50 may be provided at the center of the input unit 10.

In the case of FIG. 11(a), the third directional input A is detected by two movement detection units 50a and 50c arranged in a radial direction from each of the first direction indication locations, the first directional input P is detected by the press detection units 60, and the second directional input M is detected by two movement detection units 50b and 50d arranged in a circumferential direction perpendicular to the radial direction.

In this case, the support parts 11 may be provided at respective first direction indication locations (see FIG. 11(a)).

In the case of FIG. 11(b), the four movement detection units 50a, 50b, 50c and 50d, arranged radially around the reference location, detect the second directional input M and the third directional input A.

That is, the movement detection units 50a, 50b, 50c and 50d detect third directional input A in respective radial directions, the movement detection units 50b and 50d perform detection when second directional input M is performed after first directional input P in a direction P1 has been selected, and the movement detection units 50a and 50c perform detection when second directional input M is performed after first directional input P in a direction P2 has been selected.

Meanwhile, the character input device according to one embodiment of the present invention may be provided to enable central input C, as shown in FIG. 11.

The central input C may be performed while the entire input unit 10 is moved vertically, may be performed by providing a central input key 30 at the center of the input unit 10, as shown in FIG. 1, or may be performed using both of these constructions.

In this case, a central input detection unit 70 for detecting central input C at the reference location may further be provided.

Of course, the central input C may be also provided to be performed in two or more steps, that is, in multiple steps.

Here, when the number of direction indication locations is increased, the number of characters that can be input through one action can be increased without limit.

Accordingly, the character input device according to one embodiment of the present invention may be manufactured such that the design related to the numbers of directional inputs and direction indication locations may be freely changed depending on the number of characters, and does not require further input space, even when the number of characters is increased.

For example, when, as shown in FIGS. 13 and 14, the first directional input P is configured to be input in two steps, the second directional input M is configured to be input in one step and the third directional input A is configured to be performed in two steps, consonant characters may be input through the second directional input M and the third directional input A, and vowel characters may be input through the first directional input P.

Alternatively, vowel characters may be assigned to any one of the second directional input M and the third directional input A, and consonant characters may be assigned to the remaining directional input.

Here, whether the directional input is performed in multiple steps may be freely determined as needed. For example, in the above-described case, the second directional input M may be configured to be performed in two steps.

Furthermore, since the character input device according to one embodiment of the present invention has input characteristics for respective types of directional input (that is, the tilting of the input unit 10 or the selection of the directional pressing button 15 for the first directional input P, the movement of the input unit 10 in a circumferential direction perpendicular to a radial direction or the rotation of the input unit 10 for the second directional input M, and the movement of the input unit 10 in a radial direction for the third directional input A), a user may easily become accustomed to the operation of the character input device if arrangement is performed depending on the characteristics of the characters to be input (for example, consonant characters for the third directional input A, and vowel characters for the first directional input P).

FIGS. 13 and 14 show examples of a character input device according to embodiments of the present invention.

FIG. 13 shows the combination of one-step first directional input P, one-step second directional input M, two-step third directional input A and central input C. Referring to this drawing, vowel characters are arranged for the first directional input P and the central input C, and consonant characters are arranged for the remaining second directional input M and third directional input A.

Here, movement detection units 50 and press detection units 60 may be arranged using the two methods of FIG. 3.

Accordingly, when a user desires to input ‘ [symbol] ’, first step third directional input A in the 12 o'clock direction and first directional input P in the same direction is performed. When ‘ [symbol] ’ is desired to be input, ‘ [symbol] ’ is input in such a way that ‘ [symbol] ’ is input by performing first directional input P in the 12 o'clock direction and then performing second directional input M in the left direction and ‘ [symbol] ’ is input by performing first directional input P in the same direction from the reference location.

The first directional input P may be provided to be performed in two steps, as shown in FIG. 14.

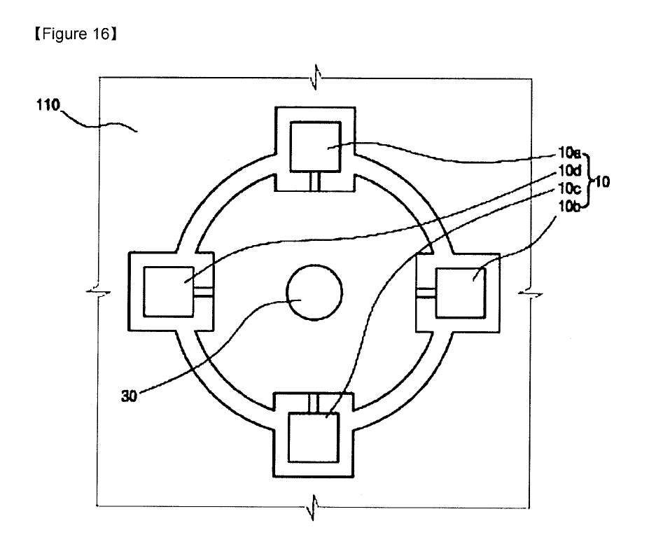

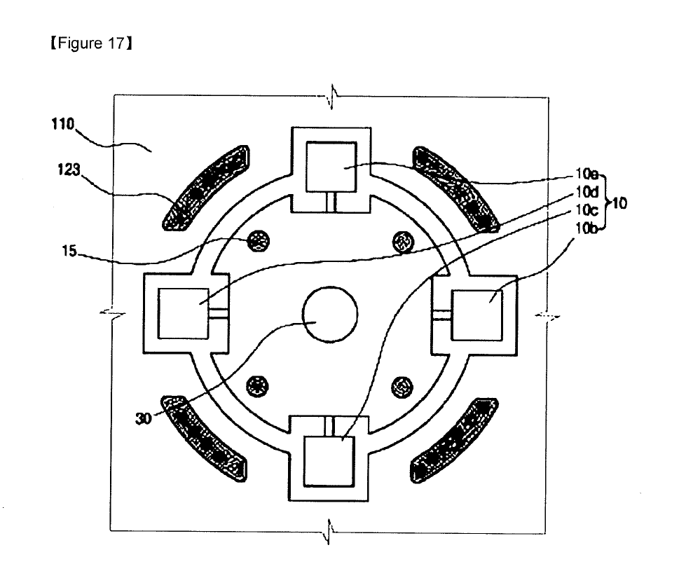

Meanwhile, the input unit 10 of the character input device according to one embodiment of the present invention may be configured to have various shapes. Although the input unit 10 is configured to have, for example, a disk shape, as shown in FIG. 1, the input unit 10 may be configured to have shapes such as those shown in FIGS. 16 and 17.

In an input unit 10 shown in FIG. 16, surrounding input keys 10a, 10b, 10c and 10d are formed to protrude at respective direction indication locations. The respective surrounding input keys 10a, 10b, 10c and 10d are not separate from the body of the input unit 10, but are integrated with the body of the input unit 10.

In this case, when first directional input P and third directional input A are performed, the respective surrounding input keys 10a, 10b, 10c and 10d can be used as if they were separate from the body of the input unit 10, and thus a user can become accustomed to the use thereof.

Here, non-slip members made of, for example, rubber, may be provided on the tops of respective surrounding input keys 10a, 10b, 10c and 10d, thereby enabling more accurate input to be performed.

Furthermore, as shown in FIG. 17, directional pressing buttons 15 are provided on one side of the body of the input unit 10, and function keys 123 may be arranged around the input unit 10.

Meanwhile, when the input unit 10 is provided to have the configurations shown in FIGS. 16 and 17, the second directional input M and the third directional input A can be detected if the movement detection units 50 are arranged at the locations of the respective surrounding input keys 10a, 10b, 10c and 10d, as shown in FIG. 11(a).

Meanwhile, as shown in FIGS. 13 and 14, character display units 80 for displaying characters input through the directional input may be further provided on a casing 110 or the input unit 10.

The character display unit 80 may be implemented in various ways. characters, input to correspond to the input actions of the input unit 10 at the time of respective types of directional input, may be arranged.

That is, as shown in FIGS. 13 and 14, first characters (‘ [symbol] ’, ‘ [symbol] ’, etc. in FIG. 13) input through third directional input A to correspond to respective second direction indication locations may be arranged on the casing 110, third characters (‘ [symbol] ’, ‘ [symbol] ’, etc. in FIG. 13) input through second directional input M may be arranged beside each of the first characters, and second characters (‘ [symbol] ’, etc. in FIG. 13) input through first directional input P to correspond to respective first direction indication locations may be arranged on the input unit 10.

In this case, since respective characters are arranged to correspond to input actions, a user can easily become accustomed to input actions.

Next, a character input device according to a fourth embodiment of the present invention will be described.

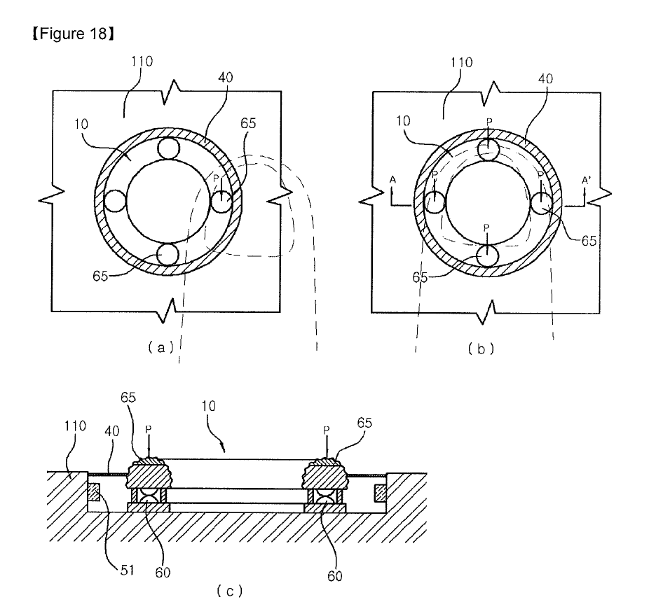

In the present embodiment, the input unit 10 of the character input device is configured to have a ring shape, as shown in FIG. 18. In the input unit 10, four first direction indication locations P1, P2, P3 and P4 are radially arranged in a ring form, and first directional input P is performed by pressing the first direction indication locations.

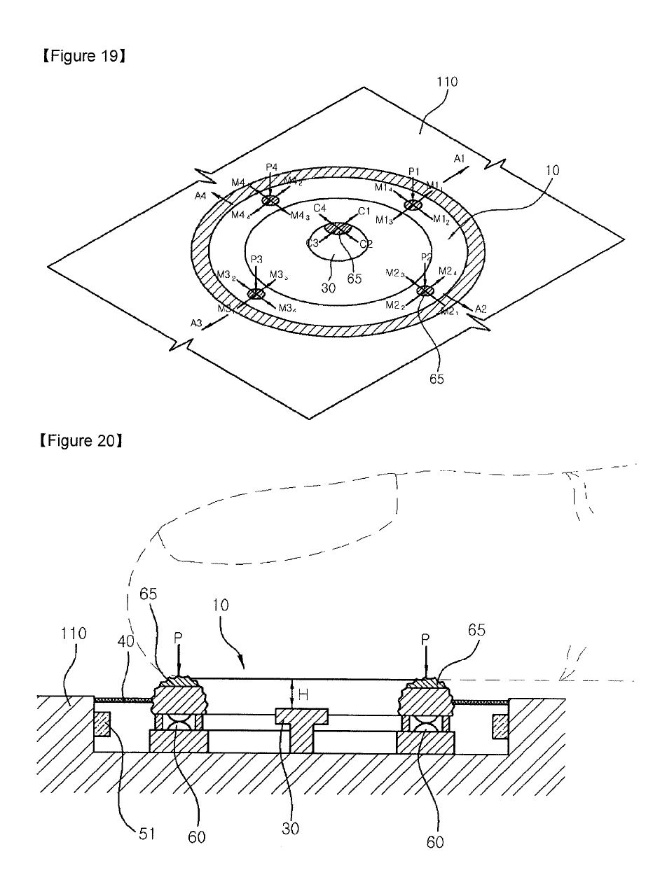

Furthermore, second direction indication locations M1₁, . . . , M2₁, . . . , M3₁, . . . , M4₁, . . . are arranged radially from the first direction indication locations P1, P2, P3 and P4 (four for each location), as shown in FIG. 19, and second directional input M is performed through movement to the second direction indication locations.

Furthermore, third directional input A is performed by moving the entire ring-shaped input unit 10 to each of the third direction indication locations A1, A2, A3 and A4 in a radial direction.

Press detection units 60, movement detection units 50 and entire movement detection units 51 (see FIG. 18(c) and FIG. 20) for detecting the first directional input P, the second directional input M and the third directional input A may be the same as those shown in the above-described embodiments.

In this case, discriminative detection units 65 are provided on each of the first direction indication locations to discriminate between the second directional input M and the third directional input A. That is, when a finger is placed on the entire input unit 10, as shown in FIG. 18(b), three or more discriminative detection units 65 at each of the first direction indication locations detect contact with a finger. When the entire input unit 10 is moved radially in this state, a control unit determines that such movement is related to third directional input A, and then extracts a character assigned to a third direction indication location, at which the third directional input A is performed.

Meanwhile, when a finger is placed on a specific first direction indication location so as to perform second directional input M at a specific location, as shown in FIG. 18(a), contact with the finger is detected by one or more of the discriminative detection units 65 at each first direction indication location. In this case, when contact with the finger is detected only by one discriminative detection unit 65, it is determined that second directional input M has been performed at a first direction indication location corresponding to the discriminative detection unit 65 that detects the finger.

Meanwhile, when contact with a finger is detected by two discriminative detection units 65, which of them is a discriminative detection unit 65 corresponding to a first direction indication location at which second directional input M is performed is determined. In this case, a first direction indication location corresponding to a discriminative detection unit 65 that first detects a finger is selected, or pressure is detected because the pressure is further applied to the specific first direction indication location to perform second directional input M, the first direction indication location is selected, and then it can be determined that second directional input is performed at the location.

Furthermore, in the present embodiment, the same character set may be assigned to the second directional input M and the third directional input A. That is, a character set assigned to four second direction indication locations provided for each of first direction indication locations in four directions is made the same as a character set assigned to third direction indication locations in four directions, and thus, the same result can be achieved even through two different types of second directional input M in such a way that third directional input A is performed immediately after second directional input M is performed in a specific direction.

Meanwhile, as shown in FIG. 19, a central input key 30 may be further provided at the reference location of the ring-shaped input unit 10. In this case, new characters, different from those input through the first, second and third directional input P, M and A, can be input through fourth directional input C by performing fourth directional input C on the central input key 30 in a radial direction. Here, fourth directional input C refers to radial directional movement or directional pressing, and uses the same reference numeral because it is a type of central input C.

In this case, when the same character set is assigned to second directional input M, which is performed through movement in a radial direction from each of the first direction indication locations, and the fourth directional input C, input can be performed by pressing each of the first direction indication locations provided on the ring-shaped input unit 10 (performing first directional input P) while performing movement on the central input key 30 (performing fourth directional input C), and, conversely, by performing movement on the central input key 30 (performing fourth directional input) while pressing each of the first direction indication locations (performing first directional input P), with the result that the successive input of two phonemes using this combination can be performed. Accordingly, using the input unit 10 according to the present embodiment, character input can be performed very quickly and conveniently.

Furthermore, in the arrangement shown in FIG. 19, the same character set may be assigned to the second directional input M and the fourth directional input C, as described above, but the same character set may be assigned to the second directional input M and the third directional input A. That is, a character set assigned to four second direction indication locations provided for each of first direction indication locations in four directions is made the same as a character set assigned to third direction indication locations in four directions, and thus, the same result can be achieved even through two different types of second directional input M in such a way that third directional input A is performed immediately after second directional input M in a specific direction is performed.

Furthermore, in the present embodiment, four first direction indication locations are arranged radially and four second direction indication locations are arranged at each of the first direction indication locations, so that input can be performed at each indication location and input in four directions can be performed through the movement of all of the central input key 30 and the input unit 10. Meanwhile, the input unit 10 may be configured to enable input at respective indication locations and input in eight directions through the movement of the central input key 30 by arranging first direction indication locations in eight radial directions and arranging eight second direction indication locations at each of the first direction indication locations. In this case, the number of types of first, second and fourth directional input P, M and C is increased, and thus third directional input A through the movement of the entire input unit 10 need not be performed. Furthermore, the same character set is assigned to the second directional input M and the fourth directional input C, thereby enabling fast character input.

In this case, when the number of characters that can be input is less than the number of required characters, the number of available characters can be increased by configuring the input unit 10 in two sets or configuring the first, second and fourth directional input P, M and C so that they can be performed in multiple steps.

Meanwhile, since the input unit 10 is provided to have a size that can be covered with a single finger when a central input key 30 is provided in the present embodiment, whether an input in question is first directional input P, which is performed through movement to each second direction indication location, second directional input M, which is performed by pressing each first direction indication location, third directional input A, which is performed through the movement of the entire input unit 10, or fourth directional input C, which is performed through the directional movement of the central input key 30, is determined. That is, when input is performed in the state in which a finger is placed or input is performed using the central input key 30, respective input actions can interfere with each other. For example, when the input unit 10 according to the present embodiment is implemented using an input key or a touch pad, the central input key 30 may cause interference in the case in which input is performed in such a way that a finger is placed on the input unit 10.

In order to avoid such interference, in the present embodiment, the height of the central input key 30 and the height of the ring-shaped input unit 10 may be set differently, and interference through fourth directional input C using the central input key 30 may be ignored when input is performed by placing a finger using a discriminative detection function.

That is, as shown in FIG. 20, when the central input key 30 is configured to be lower than the ring-shaped input unit 10 by height H, interference with fourth directional input C performed on the central input key 30 can be avoided in the case in which first, second and third directional input P, M and A are performed on the ring-shaped input unit 10. In this case, in order to perform fourth directional input C, input may be performed by bringing a finger into contact only with the central input key 30 using a method of erecting a finger or the like. Here, the central input key 30 and the ring-shaped input unit 10 may be included in the range covered with a single finger.

Furthermore, as shown in FIG. 19, in order to perform a discriminative detection function, discriminative detection units 65 may be provided in respective first direction indication locations P1, P2, P3 and P4 and the central input key 30. In the case, when contact with a finger is detected by discriminative detection units 65 provided in the central input key 30, this is identified as fourth directional input through the central input key 30. Furthermore, when contact with a finger is detected by two or more discriminative detection units 65 at each first direction indication location and the central input key 30, it is determined that a finger is placed on the entire input unit 10, and thus input in question is identified as third directional input A. Furthermore, when contact with a single finger is detected by only one of the discriminative detection units 65 at each first direction indication location, input in question is identified as first directional input P through movement from a first direction indication location to a second direction indication location or as first directional input P at the first direction indication location.

The ring-shaped input unit 10 provided with the central input key 30 as described above may function as a mouse. That is, the central input key 30 is used for the movement of a mouse point, and the ring-shaped input unit 10 may be used for the left button, right button and up/down scrolling of a mouse. In this case, since the ring-shaped input unit 10 provided with the central input key 30 is included within the range of contact of a single finger and the movement of the pointer of the central input key 30 and the pressing of the left or right button of the ring-shaped input unit 10 may be performed, file dragging or dragging can be performed using the above action.

In the above-described drawing, reference numeral 40 designates a return element. The return element 40 includes an elastic material, and is provided to return the input unit 10, with which second directional input M or third directional input A has been performed, to the original position thereof.

Next, a character input device according to a fifth embodiment of the present invention will be described.

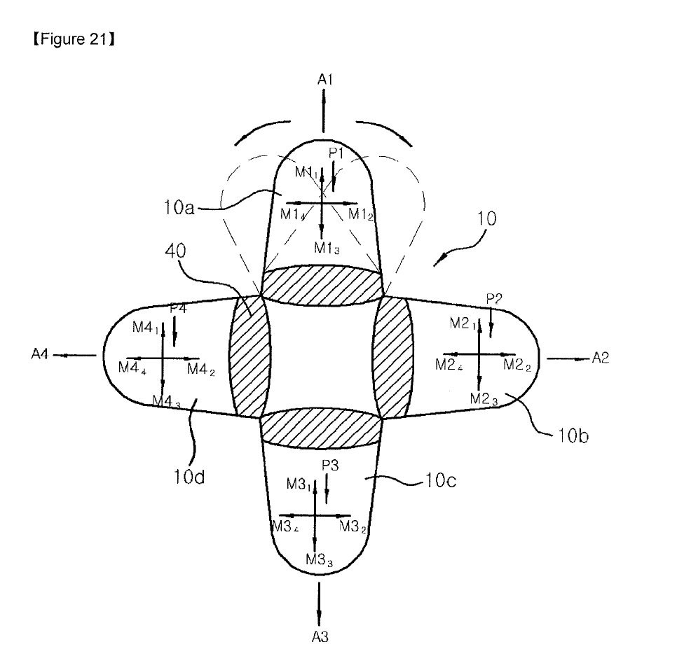

In the present embodiment, the input unit 10 includes a central region provided at a reference location and a plurality of surrounding input keys 10a, 10b, 10c and 10d arranged radially around the central region and connected to the central region through elastic return elements 40, as shown in FIG. 21.

Furthermore, a central input key capable of performing one or more of directional pressing and directional movement may be further provided in the central region.

Here, the input unit 10 including the central region and the surrounding input keys 10a, 10b, 10c and 10d in the present embodiment can realize all of the input actions in the above-described embodiments.

In particular, second directional input M, input through movement from each first direction indication location to a second direction indication location, may be performed through the movement of the entire input unit 10 at the time of inward input or outward input with respect to the central region, or may be input by moving only each of the surrounding input keys 10a, 10b, 10c and 10d using the elastic force of a return element 40 in a lateral direction.

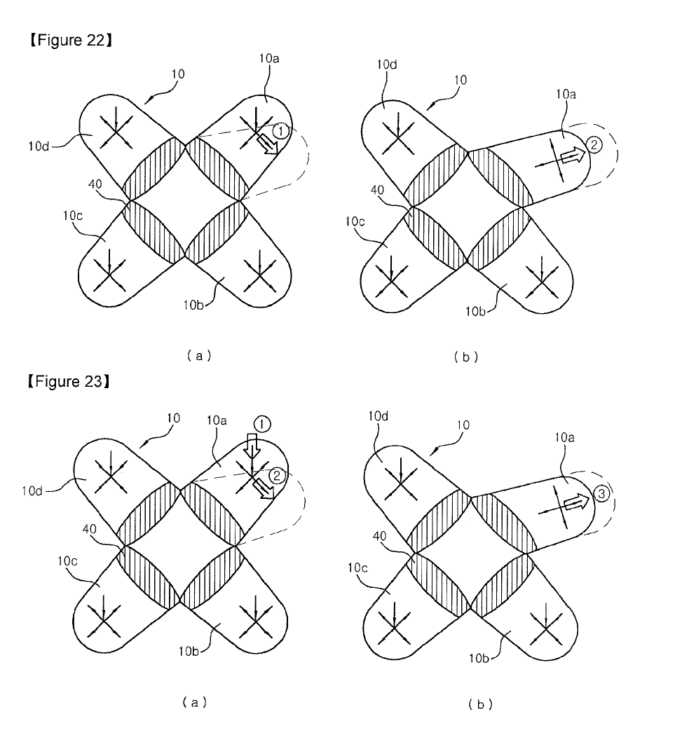

Furthermore, when second directional input M is performed using the surrounding input key 10a of the surrounding input keys 10a, 10b, 10c and 10d (see \textcircled{1} in FIG. 22(a)), the surrounding input key 10a is inclined in the direction in which the second directional input M is performed, and a character, first assigned to the second direction indication location, or a second character, different from that character, is newly indicated at a movement and second direction indication location (see 10a in FIG. 22(b)) around the location at which the second directional input M has been performed. In this case, one of such second characters may be input through movement and second direction input M with respect to a second direction indication location at this location (see \textcircled{2} in FIG. 22(b)). Through this input action, the surrounding input key 10a is moved, as indicated by a dotted line in FIG. 22(b).

This input method may start with first directional input P through the pressing of a first direction indication location of surrounding input keys 10a, 10b, 10c and 10d. That is, after second directional input M has been performed (\textcircled{2} in FIG. 23(a)) in the state in which the first directional input P has been performed (\textcircled{1} in FIG. 23(a)), second directional input M can be performed again (\textcircled{3} in FIG. 23(b)). Through these input actions, the surrounding input key 10a is moved, as indicated by the dotted line in FIG. 22(b). When first directional input P is included, characters, different from those in the case in which only second directional input M is included, may be input. By doing this, three different phonemes can be input through successive actions, and thus very fast input of characters can be performed.

Although the above-described character input device may be implemented using typical input keys, it may be also implemented on a touch pad or a touch screen. In this case, the touch pad or touch screen is configured to detect pressing and the pressing movement of a finger in a lateral direction as well as contact so as to detect first, second and third directional input P, M and A.

Furthermore, the upper surface of the touch pad or touch screen may be made of flexible elastic material to enable movement or pressing input to be performed without hindrance.

According to at least one embodiment, each of characters, numbers and symbols can be input through a single action based on first, second, third or fourth directional input or combined directional input using a single input unit, thereby reducing the space required for character input and enabling fast and accurate character input.

Furthermore, the number of types of directional input and the number of direction indication locations can be freely adjusted and realized through design change depending on the number of characters required to be assigned, and a larger input space is not required, even when the number of characters to be assigned is increased.

Moreover, since the character input device according to the present invention has input characteristics for respective types of directional input, characters are separately arranged for the respective types of directional input depending on the characteristics of the characters, thereby enabling a user to become easily accustomed to the operation of the character input device.

It will be apparent to those having ordinary skill in the technical field to which the present invention pertains that the above-described present invention is not limited to the above-described embodiments and the attached drawings, but that various substitutions, modifications and variations are possible within a range that does not depart from the technical spirit of the present invention.

What is claimed is:

1. A character input device, comprising:
an input unit provided such that i) first directional input which is selected by directional pressing or tilting one of a plurality of first direction indication locations arranged radially from a reference location and spaced apart from one another, ii) second directional input which is configured to be performed through directional movement from each of the first direction indication locations to one of a plurality of second direction indication locations arranged radially around the first direction indication location, and iii) combined directional input different from the first directional input and the second directional input through combination of the first directional input and the second directional input can be performed respectively;
at least one press detection unit configured to detect the first directional input;
at least one movement detection unit configured to detect the second directional input; and
a control unit configured to extract and display a character code, assigned to each selected one of the direction indication locations, from a memory unit based on results of the detection of the press detection unit and the movement detection unit.

2. The character input device as set forth in claim 1, wherein third directional input for inputting characters assigned to third direction indication locations arranged radially from the input unit is configured to be performed through movement of the entire input unit to the third direction indication locations, and wherein the character input device further comprises at least one entire movement detection unit provided on one side of the input unit or outside the input unit to detect the third directional input.

3. The character input device as set forth in claim 2, wherein the first to fourth directional inputs are configured to be performed in multiple steps of two or more.

4. The character input device as set forth in claim 2, further comprising at least one discriminative detection unit configured to detect contact of a finger with each of the first direction indication locations or a center detection unit configured to detect contact of a finger with the reference location so as to discriminate between the second directional input based on each of the second direction indication locations and the third directional input based on radial direction movement of the entire input unit.

5. The character input device as set forth in claim 1, further comprising a central input key provided at the reference location of the input unit and configured to perform fourth directional input through one or more of the directional pressing and the directional movement;
wherein the central input key comprises one or more of a press detection unit configured to detect the directional pressing and a movement detection unit configured to detect the directional movement.

6. The character input device as set forth in claim 1, wherein:
the input unit comprises a central region provided at the reference location and a plurality of surrounding input keys arranged radially from the central region and connected to the central region through elastic return elements; and
the first direction indication locations are provided for the respective surrounding input keys, and the first directional input which is configured to be performed through the directional pressing of each of the first direction indication locations, and the second directional input which is configured to be performed through direction movement from each of the first direction indication location to one of the second direction indication locations arranged radially from the first direction indication location, based on elastic deformation of the input key with respect to the central region, are configured to be performed.

7. The character input device as set forth in claim 6, wherein third directional input for inputting characters assigned to third direction indication locations arranged radially from the input unit, is configured to be performed through movement of the entire input unit to the third direction indication locations, and wherein the device further comprises at least one entire movement detection unit provided on one side of the input unit or outside the input unit to detect the third directional input.

8. The character input device as set forth in claim 1, further comprising a return element configured to return the input unit to an original location thereof.

9. A character input device, comprising:
an input unit provided such that i) first directional input which is configured to be performed through selection of one from among a plurality of first direction indication locations arranged radially on the input unit itself and spaced apart from one another, ii) second directional input which is configured to be performed through movement from each of the first direction indication locations to one of second direction indication locations arranged circumferentially around the first direction indication location, and iii) third directional input which is configured to be performed through entire movement from a reference location to one of third direction indication locations arranged radially from the reference location and spaced apart from one another can be performed respectively;
at least one movement detection unit configured to detect the second directional input and the third directional input of the input unit;
at least one press detection unit configured to detect the first directional input; and
a control unit configured to extract and display a character code, assigned to each selected direction indication location, from a memory unit based on results of the detection of the movement detection unit and the press detection unit.

10. The character input device as set forth in claim 9, wherein the first to third directional inputs are configured to be performed in multiple steps of two or more on each of the direction indication locations.

11. The character input device as set forth in claim 9, wherein the second directional input is configured to be performed in such a way that the input unit is rotated around the reference location in right or left direction.

12. The character input device as set forth in claim 9, wherein central input that is configured to be performed by any one of a method of moving the entire input unit in a substantially vertical direction or a method of selecting a central input key provided on the input unit can be inputted in one step or more.

13. The character input device as set forth in claim 9, further comprising a return element configured to return the input unit to the reference location.

14. The character input device as set forth in claim 9, further comprising at least one character display unit provided on any one of the input unit and a casing in which the input unit is mounted, and configured to separately display characters, assigned to the respective direction indication locations, in response to input actions of the input unit when each of directional inputs is performed.

15. The character input device as set forth in claim 11, further comprising a support unit configured to support a bottom of the input unit;
wherein the support unit comprises a plurality of fixed support parts provided opposite each other and a rotating support part provided between the fixed support parts, and configured to come into contact with any one of the plurality of the fixed support parts while rotating along with the input unit; and
wherein the movement detection unit is provided on any one of the fixed support part and the rotating support part and detects contact between the fixed support part and the rotating support part.

16. The character input device as set forth in claim 11, further comprising a support unit configured to support a bottom of the input unit;
wherein the support unit comprises a contact protrusion extended from the support unit; and
wherein the movement detection unit is provided on a path of rotation of the contact protrusion and is configured to detect contact with the contact protrusion when the support part rotates along with the input unit.

17. A character input device, comprising:
an input unit provided such that i) first directional input which is selected by directional pressing or tilting one of a plurality of first direction indication locations arranged radially from a reference location and spaced apart from one another, ii) second directional input which is configured to be performed through directional movement from each of the first direction indication locations to one of a plurality of second direction indication locations arranged radially around the first direction indication location, and iii) combined directional input different from the first directional input and the second directional input through combination of the first directional input and the second directional input can be performed respectively;
first detection means for detecting the first directional input;
second detection means for detecting the second directional input; and
means for extracting and displaying a character code, assigned to each selected one of the direction indication locations, from a memory unit based on results of the first and second detection means.
